(19) United States
(12) Patent Application Publication
(10) Pub. No.: US 2009/0147956 A1
(43) Pub. Date: Jun. 11, 2009

(54) Sharing a Secret Element

(75) Inventors: Frederic Rousseau, Montigny Le Bretonneux (FR); Jean-Michel Tenkes, Plaisir (FR); Marc Mouffron, Saint Remy Les Chevreuse (FR)

Correspondence Address: MILLER, MATTHIAS & HULL, ONE NORTH FRANKLIN STREET, SUITE 2350, CHICAGO, IL, 60606, US

(73) Assignee: EADS SECURE NETWORKS, Elancourt (FR)

(21) Appl. No.: 12/158,206

(22) PCT Filed: Dec. 19, 2006
(86) PCT No.: PCT/IB06/03702

§ 371 Date: Dec. 1, 2008

(30) Foreign Application Priority Data
Dec. 20, 2005 (FR) 05 12978

(51) Int. Cl. H04K 1/00

(52) U.S. Cl. 380/257

(57) ABSTRACT

A secret element is shared with a cryptographic module. The secret element can be obtained from at least first and second partial secret information items. A first transmission transmits the first partial secret information item to the cryptographic module but not the first partial information item, this second transmission being separate from the first transmission. The secret element can then be obtained in the cryptographic module from the first and second partial secret information items transmitted.

The present invention relates to cryptography, and more precisely to sharing a secret element in a cryptographic system.

It finds applications in particular in the field of secure communications in which a plurality of cryptographic modules share a secret element, such an encryption key, for example.

Cryptographic systems may comprise cryptographic modules that have a secret element in common. In such conditions there arises the problem of sharing the common secret element between cryptographic modules.

Some cryptographic systems enable different cryptographic modules to share the same secret element by implementing a protocol between them.

This applies with the Diffie-Hellman and Menezes-Qu-Vanstone type dynamic key agreement protocols.

For example, patent document WO 98/18234 “Key agreement and transport protocol with implicit signatures” (Vanstone, Menezes, and Qu) proposes a method of dynamic and collective construction of a secret element common to first and second cryptographic modules, which in this instance is a session key. To generate such a session key, the first and second cryptographic modules exchange information in accordance with a particular protocol. In such conditions, the secret element is thus obtained dynamically and collectively by at least two cryptographic modules.

In that type of system, the sharing of a secret element between at least two cryptographic modules requires a multidirectional exchange of messages between those modules, which remains relatively easy to implement between the cryptographic modules, but which may involve a large number of combinations and therefore be highly complex in a system based on sharing a secret element between a larger number of cryptographic modules.

Some other cryptographic systems based on sharing a secret element are founded on unidirectional distribution of the secret element concerned. In such conditions the secret element exists beforehand and is sent to a plurality of cryptographic modules of the system.

For example, such a system uses a protocol of the OTAR (Over The Air Rekeying) type, for example as defined by the APCO-25 standard from the Association of Public safety Communications Officials of the American National Standards Institute (ANSI/TIA-102.AACA-1 “APCO Project 25 Over The Air Rekeying Protocol”) and the equivalent protocol for the ‘Terrestrial Trunked Radio’ standard defined by the European Telecommunications Standards Institute (ETSI EN 300 392-7 “TETRA Voice+Data Part 7 Security” and its complement “TETRA MoU SFPG Recommendation02 End-to-End Encryption”, MoU standing for Memorandum of Understanding and SFPG standing for Security and Fraud Prevention Group). Such protocols enable unidirectional distribution of the same secret element to a plurality of cryptographic modules.

Accordingly, if the cryptographic system comprises a large number of cryptographic modules, it is easier to use secret sharing based on unidirectional distribution than secret sharing based on a dynamic agreement protocol as referred to above.

However, in cryptographic systems using unidirectional distribution protocols there arises the problem of protection against attacks aiming to violate the secrecy of the information distributed. In fact, in some unidirectional distribution protocols, the secret element is sent in a single distribution protocol sequence, which may represent a weakness in the face of certain attacks.

Another problem of these latter systems resides in the format of the protocol sequence provided for the secret element. In fact, this format may be determined by a standard. It therefore imposes a maximum size on the secret element that may not suit the secret element that is to be shared in the cryptographic system. This applies in particular if a secret element larger than that covered by the standard is to be distributed.

Some standards provide different messages for distributing secret elements of different sizes. For example, messages are provided for distributing a secret element with respective sizes of up to 128 bits, 256 bits, 160 bits or 2048 bits.

However, even if that type of standard provides some flexibility as to the size of the secret element to be distributed, the size chosen nevertheless continues to be limited by the maximum size that one of the messages defined by the standard can manage. Thus a system based on such a standard cannot transmit unidirectionally a secret element having a size greater than that maximum size.

Cryptographic systems based on unidirectional distribution of the shared secret element therefore have the drawback of not allowing great flexibility as to the format of the secret element to be shared.

There also exist methods for sharing a common secret element known as ‘broadcast encryption’ processes that are based on the distribution of partial information. For example, patent document EP 0 641 103 “Method and apparatus for key distribution in a selective broadcasting system” (Fiat) describes a system using such a method. That document proposes to broadcast a common secret element in the form of partial information enabling the secret element to be reconstituted by applying an exclusive-OR operation. Each of the modules in a given set of cryptographic modules receives all of the partial information required to obtain the secret element. However, a given module can effectively access only a portion of the received information. Consequently, to reconstruct the secret element, this module recovers by other means received information to which it does not have access.

In such a system, any partial information required for reconstructing the common secret element is broadcast on the same channel, generally to all the cryptographic modules. That feature has the drawback of providing a channel for attacking the secrecy of the element to be shared.

Moreover, an entropy value of the secret element, i.e. a measure of the range of possible values for the secret element as defined in the Shannon sense, is substantially identical to an entropy value of each of the broadcast items of information. As a result, such a system does not provide any solution to the problem of flexibility in relation to the format of the element referred to above. Moreover, in that system, given the entropy value of the secret element, a relatively large number of messages must be generated for transmitting the secret element to each of the modules.

An object of the present invention is to propose a way to distribute a secret element shared by a plurality of cryptographic modules of a cryptographic system that protects the secret character of the shared element. Furthermore, in an implementation of the present invention, distribution of the invention offers flexibility as to the size of the secret element.

In accordance with embodiments of the present invention, distribution is founded on the fact that the secret element to be shared is transmitted to the various cryptographic modules in the form of at least two partial secret information items that are transmitted separately, in a partitioned, independent, or distinct fashion, these terms being usable interchangeably to characterize the transmission of partial secret information items in the present invention. Starting with all these partial secret information items, it is possible to obtain the secret element concerned.

It should be noted that there is no limit on the number of partial secret information items transmitted relative to the secret element to be shared, or common element. Such distribution therefore affords great flexibility as regards the format and in particular the size of the secret element.

By transmitting the various partial secret information items relating to the common secret element separately, the secrecy of the common element may be protected effectively. In fact, as different partial secret information items are not transmitted on the same transmission channel, mounting an attack on its secrecy is more complex as the secret element is divided between at least two separate transmissions.

Moreover, in such conditions, if the size of the secret element is greater than the size of each of the partial information items, it is possible to reconstitute a secret element that is larger than that maximum size by transmitting other partial secret information items, even if an OTAR type transmission protocol is used to transmit a partial secret information item and the size of that partial secret information item is therefore limited by the maximum size allowed by the protocol.

Such a distinction may be physical; for example it may correspond to physically separate transmission channels. The distinction may also be logical; for example the first and second transmissions may be effected in accordance with different cryptographic parameters, with different confidentiality, authentication, or integrity keys. Distinguishing the respective partial secret information items transmitted by combining the above distinctions may also be envisaged.

In a preferred embodiment of the present invention, separate transmission channels are provided for transmitting the various partial secret information items separately. The present invention is not in any way limited to an embodiment of that kind. In fact, it covers any embodiment that can distinguish between transmission of different partial secret information items to protect secrecy effectively. The present invention is described below in its application to using two channels to transmit partial secret information items.

To enhance the separate nature of the transmissions, the partitioning of the two transmissions may further be of a temporal nature, i.e. the first and second partial secret information items may be transmitted at different times. For example, the first partial secret information item may be injected into the cryptographic module during a stage of fabrication of the module, a stage of initialization of the module, a stage of first use of the module, a stage of initial definition of a group of modules, or a stage of dynamic redefinition of a group of modules, and the second partial secret information item may be received during normal operation of the cryptographic module.

It should be noted that the secret element cannot be obtained only from partial information items transmitted in a single transmission. In fact, each transmission corresponds to a strictly partial transmission of said element. This means that an attack aimed at all except one of the first and second partial information transmissions cannot under any circumstances obtain the common secret element.

Moreover, by way of illustrative and non-limiting example, it is considered below, for greater clarity, that the secret element is transmitted in the form of first and second partial secret information items. It should nevertheless be noted that there is no limit on the number of partial secret information items transmitted relative to the secret element and therefore on the number of separate partial transmissions to be effected.

The first and second partial secret information items may themselves be transmitted in the form of a plurality of respective partial secret information items. Below, by way of illustration only, the first partial secret information item is transmitted in the form of a single information item K₀, and the second partial secret information is transmitted in the form of a plurality of information items K₁-Kₙ.

A first aspect of the present invention proposes a method of sharing a secret element with at least one cryptographic module. For a secret element that is obtainable from at least first and second partial secret information items, the method comprises:
/a/ a first transmission for transmitting the first partial secret information item to the cryptographic module but not the second partial information item;
/b/ a second transmission for transmitting the second partial secret information item to the cryptographic module but not the first partial information item, said second transmission being separate from the first transmission;
/c/ obtaining the secret element in the cryptographic module from the first and second partial secret information items transmitted.

By means of these features, by partitioning the secret element to be shared in this way, it is possible firstly to share a large secret element, and secondly to protect against attacks on the secrecy of the shared element. In fact, by transmitting the secret element in this partitioned form, it is possible to transmit a secret element of size that is relatively large, given the format limitations that are imposed by certain standards, as indicated above. Moreover, by partitioning the transmission into a plurality of independent separate transmissions, it is possible to increase the protection against attacks by making any reconstruction of the secret element by a third party more complex.

In a preferred implementation of the present invention, an entropy value of the secret element is substantially equal to a cumulative entropy value of the first and second partial secret information items, i.e. the sum of the entropy values of the first and second partial information items. It is therefore possible to minimize the overall quantity of information transmitted in relation to a given secret element, in particular compared to the above-mentioned prior art systems in which an exclusive-OR operation is effected on the partial information items transmitted.

In an implementation of the present invention, the aim is to maximize the entropy of the secret element relative to the respective entropies of the various partial information items.

It should be noted that, in an implementation of the present invention, a cryptographic module is able to obtain the secret element from partial information items independently and autonomously of the other cryptographic modules of the same cryptographic system, in particular in contrast to cryptographic modules that obtain the secret element using a dynamic key agreement protocol, as described above.

To distinguish, partition, the first and second transmissions, the first transmission may be effected in a first physical transmission channel and the second transmission may be effected in a second physical transmission channel separate from the first physical channel. In this way the secret element is relatively well protected from attack.

Also, the first and second physical channels may be radio channels using respective different radio technologies. For example, there may be provided one channel using a short-range radio technology such as Bluetooth and another channel using a cellular radio technology such as GSM (Global System for Mobile communications).

The first and second physical channels being physical channels that use different technologies may also be envisaged. For example, a direct injection channel using an Internet technology conforming to the IPSEC (Internet Protocol SECurity) transmission protocol may be provided on a cable medium together with another channel using some other technology.

The first physical channel may also be a cable channel with direct injection into the cryptographic module and the second physical channel may be a radio channel.

The first physical channel may correspond to a connection of the cryptographic module to a storage peripheral and the second physical channel may be a radio channel.

The first and second transmissions may also be distinguished by effecting the first transmission in a first logical transmission channel and the second transmission in a second logical transmission channel separate from said first logical channel, but established on the same physical channel as the first logical channel.

In the step /c/ the secret element may be obtained by applying a one-way function to the first and second partial secret information items.

A second aspect of the present invention proposes a cryptographic method implemented in a cryptographic module using a secret element, wherein the secret element is obtained from at least first and second partial secret information items by a sharing method of the first aspect of the present invention.

There may additionally be provision for also using a personalization key to implement such a cryptographic method.

The personalization key and the first partial secret information item may then be received in the cryptographic module via the same physical channel.

A third aspect of the present invention proposes a cryptographic module of a cryptographic system adapted to share a secret element that can be obtained from at least first and second partial secret information items, the partial secret information items enabling the secret element to be obtained.

The cryptographic module may comprise:
a receive interface adapted to receive, by a first transmission, the first partial secret information item but not the second partial information item and to receive, by a second transmission separate from the first transmission, the second partial secret information item but not the first partial information item;
a unit for obtaining secret elements adapted to obtain the secret element from the first and second partial secret information items; and
a cryptographic unit adapted to execute a cryptographic operation on the basis of the secret element.

Such a cryptographic operation may correspond to an operation such as encrypting and/or proving the integrity, respectively decrypting and/or verifying the integrity, of the data to be transmitted, respectively the data received.

In an embodiment of the present invention, the receive interface comprises:
a first interface adapted to receive the first partial secret information item; and
a second interface separate from the first interface and adapted to receive the second partial secret information item.

The first interface may be adapted to receive the first partial secret information item via a direct injection cable channel and the second interface may be adapted to receive the second partial secret information item via a radio channel.

The direct injection channel may correspond to a connection to a storage peripheral.

The cryptographic unit may be adapted to effect cryptographic operations by means of a cryptographic algorithm parametered by a personalization key; a cryptographic operation corresponding, for example, to a data encryption or decryption operation. The first interface may be further adapted to route the personalization key to the cryptographic unit and the first partial secret information item to the unit for obtaining secret elements.

Such a cryptographic module may be further adapted to share with another cryptographic module a secret information item relating to an individual identity of that cryptographic module.

When the cryptographic module belongs to a group of cryptographic modules, it may be further adapted to share a secret information item relating to an identity of said group of cryptographic modules.

A fourth aspect of the present invention proposes a terminal comprising a cryptographic module according to the third aspect of the present invention.

A fifth aspect of the present invention proposes a center for distribution of a secret element in a cryptographic system comprising a plurality of cryptographic modules.

The distribution center comprises:
a partitioning unit adapted to partition a secret element into at least first and second partial secret information items, said secret element being obtainable from said partial secret information items; and
an interface adapted to distribute both said first partial secret information item but not the second partial secret information item, and said second partial secret information item but not the first partial secret information item, to the plurality of cryptographic modules, respectively by a first transmission, and by a second transmission separate from the first transmission.

A sixth aspect of the present invention proposes a cryptographic system comprising a plurality of cryptographic modules according to the third aspect of the present invention and a secret element distribution center according to the fifth aspect of the present invention, wherein a secret element is distributed by means of a sharing method according to the first aspect.

Other aspects, aims, and advantages of the invention will become apparent on reading the description of one of its implementations.

The invention can also be better understood with the aid of the drawings, in which:

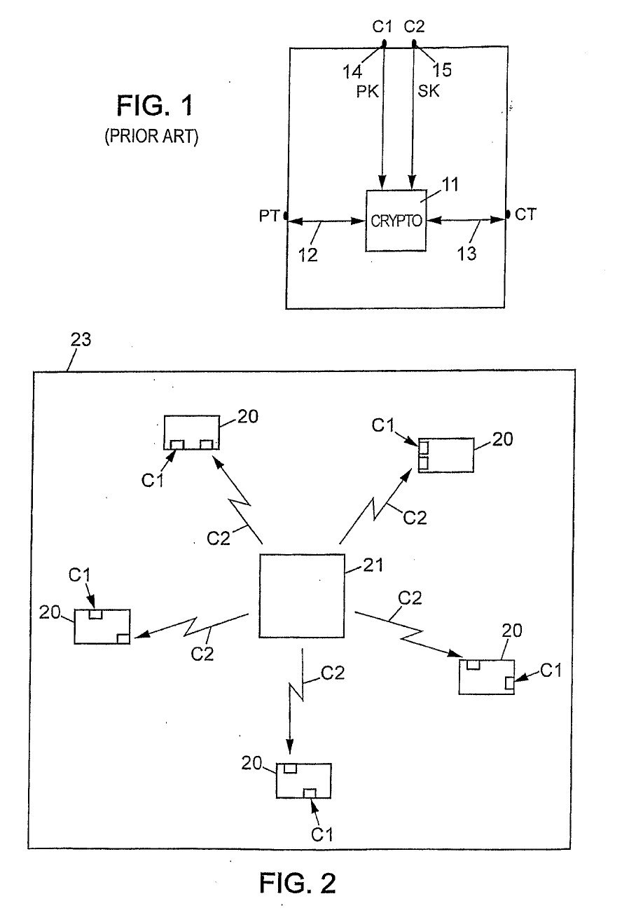

FIG. 1 shows a prior art cryptographic module;

FIG. 2 shows an embodiment of a cryptographic system according to the invention;

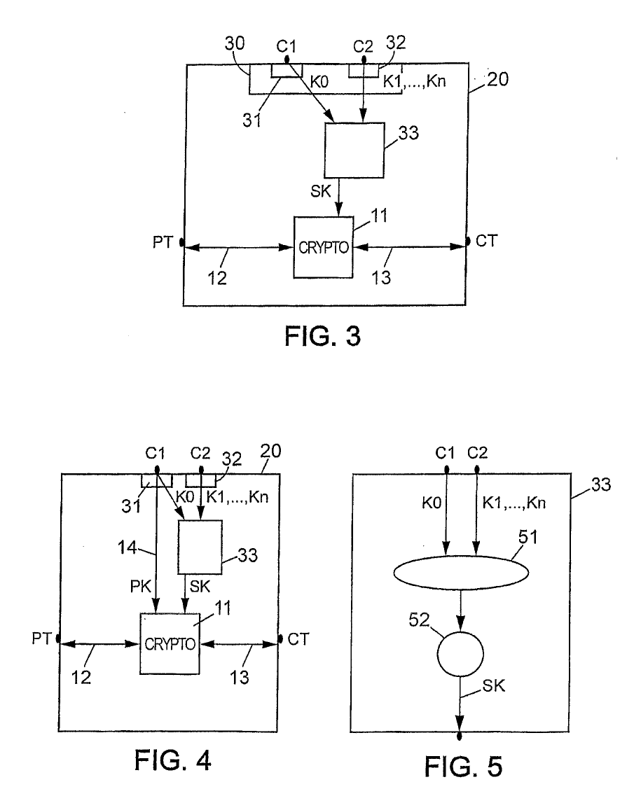

FIG. 3 shows an architecture of an embodiment of a cryptographic module according to the present invention;

FIG. 4 shows another architecture of an embodiment of a cryptographic module according to the present invention;

FIG. 5 shows an architecture of an embodiment of a unit according to the present invention for obtaining a shared secret element;

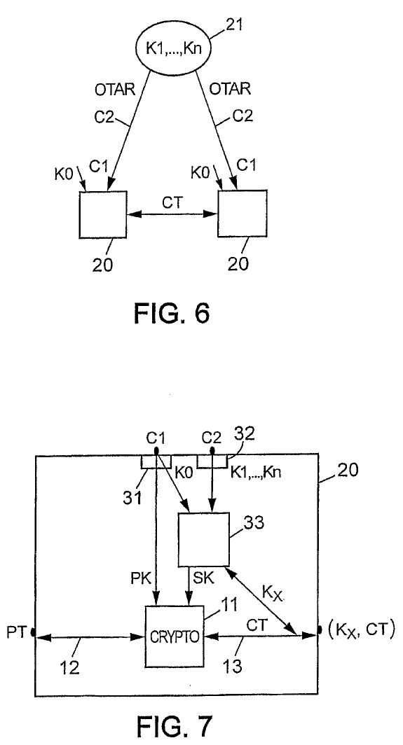

FIG. 6 shows an embodiment of the present invention in which a first transmission is effected via a first channel and a second transmission is effected via a second channel;

FIG. 7 shows an architecture of an embodiment of a cryptographic module according to the present invention;

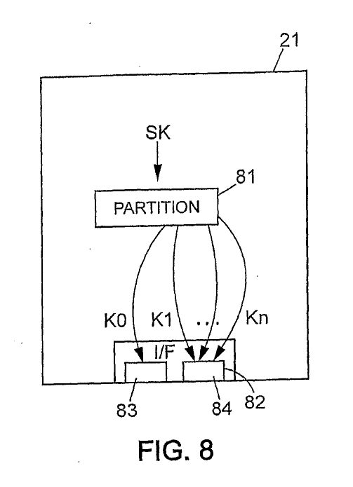

FIG. 8 shows an embodiment of a secret element distribution center according to the present invention.

The present invention is described below in an application thereof to cryptographic modules that have a direct data injection channel, i.e. a channel corresponding to a physical connection via a mechanical or electrical interface connected directly to the cryptographic module. Such a direct injection channel may correspond to transmission by an optical fiber, serial link type transmission, or transmission from a smart card, or USB (Universal Serial Bus) key, or some other memory medium. A direct injection channel that is already present in certain prior art cryptographic modules may advantageously be used for this purpose.

FIG. 1 shows such a prior art cryptographic module. Such a cryptographic module comprises a cryptographic unit 11 that operates in accordance with a cryptographic algorithm. This cryptographic unit receives at a first input 14 a cryptographic personalization key PK and at a second input 15 a secret element or session key SK. The personalization key PK may correspond to a cryptographic algorithm parameter (Operator Variant Algorithm Configuration Field (OP,OPc)), for example, as defined in the 3^{rd} Generation Partnership Project (3GPP) document TS 35.206 v6.0.0. “3G Security: specification of the MILENAGE algorithm set; An example algorithm set for the 3GPP authentication and key generation function f1, f1*, f2, f3, f4, f5 and f5*; Document 2: algorithm specification; Release 6”.

Below, by way of illustrative and non-limiting example, the secret element SK to be shared that is distributed in accordance with an implementation of the present invention is a session key.

Using the keys PK and SK, the cryptographic unit 11 is able to encrypt plain text PT received on a channel 12 and ciphered text CT to be sent on a channel 13 and conversely to decrypt a received encrypted text.

In a different embodiment, also using the keys PK and SK, the cryptographic unit 11 is able to prove the integrity of plain text PT received on a channel 12 in cryptographic text CT to be sent on a channel 13 and conversely to verify the integrity of a received cryptographic text.

In an embodiment of the present invention, an injection channel corresponding to the first input 14 may advantageously be used as the first transmission channel for transmitting the first partial secret information item K₀.

FIG. 2 shows an embodiment of a cryptographic system 23 of the present invention. Such a system comprises a plurality of cryptographic modules 20 and a key distribution center (KDC) 21 adapted to distribute secret elements in an embodiment of the present invention. By way of illustrative example, the first partial secret information item K₀ is transmitted by a first channel c1 and the second partial secret information item K₁-Kₙ is transmitted by a second channel c2, for example an OTAR type radio channel.

FIG. 3 shows an architecture of an embodiment of a cryptographic module 20 of the present invention. Such a cryptographic module comprises an interface 30 adapted to receive partial secret information items in respective separate transmissions. This interface 30 comprises a first interface unit 31 adapted to receive the first partial secret information item K₀ via the first transmission channel c1, and a second interface unit 32 adapted to receive the second partial secret information item via the second channel c2. The cryptographic module further comprises a unit 33 adapted to obtain the distributed secret element SK from the first and second partial secret information items and a cryptographic unit 11 adapted to execute a symmetrical cryptography algorithm. This cryptographic unit is adapted to encrypt a text PT and/or to prove the integrity of a text PT received on the channel 12 in a text CT to be sent on the channel 13 on the basis of the secret element SK supplied by the unit 33. This cryptographic unit is also adapted to decrypt a text CT and/or to verify the integrity of a text CT received via the channel 13 and to supply a text PT on the channel 12 on the basis of the secret element SK supplied by the unit 33.

The present invention may easily be implemented in cryptographic modules based on cryptographic algorithms using other input parameters to perform a cryptographic operation, for example encrypting the text PT or proving its integrity. In fact, the present invention is in no way limited by the type of symmetrical cryptography algorithm to be executed in the cryptographic unit 11.

Accordingly, FIG. 4 shows another cryptographic module architecture according to an embodiment of the present invention in which the cryptographic algorithm receives as further input a personalization key PK. The interface unit 31 is adapted to route the key PK to the cryptographic unit 11 and the first partial secret information item K₀ to the unit 33. The personalization key PK and the first partial secret information item may advantageously be injected into the cryptographic module via the same interface 31. They may be injected at different times. For example, the personalization key may be injected into the cryptographic module 20 in the factory and the first partial secret information item injected later, at the time of commissioning the cryptographic module, or even later, in a stage of initialization of the module, a stage of initial definition of a group of modules or a stage of dynamic redefinition of a group of modules. The first partial secret information item may even be updated regularly when the cryptographic module is operating. The personalization key and the first partial secret information item may also be injected at substantially the same time.

Subject to particular conditions of implementation of the present invention, it is possible to provide for the value of the key PK to be similar or identical to that of the first partial secret information item K₀. The same information item may then with advantage be used as input for the cryptographic unit 11 and as input for the unit 33.

FIG. 5 shows the architecture of a unit 33 constituting an embodiment of the present invention for obtaining a shared secret element. Such units advantageously employ a one-way function that takes the first and second partial secret information items into account.

In FIG. 5, the unit for obtaining secret element 33 receives the first and second partial secret information items. The received partial secret information items are then supplied to a combination function 51.

That combination function 51 for combining the first and second partial secret information items may be of any type. It may be a concatenation function or advantageously any other non-linear function.

In a preferred embodiment of the present invention, this function determines a combined information item that is then supplied to a cryptographic function 52. This function may create a digital fingerprint of the combined information item received from the combination function 51. This cryptographic function 52 is adapted to obtain the shared secret element SK from the combined information supplied item by the combination function 51.

The cryptographic function 52 may be a hashing function of the type well-known to the person skilled in the art, for example, or a decapsulation function corresponding to a KEM (key encapsulation mechanism) type encapsulation function as defined by the ISO/IEC standard 18033-2 ‘Information technology; Encryption algorithms; Part 2 Asymmetric cipher’.

The combination function and the cryptographic function preferably obtain an element SK having an entropy value substantially equal to the sum of the entropy values of the first and second partial secret information items.

When the unit 33 obtains the secret element SK, it is then supplied as input to the cryptographic unit 11. The cryptographic unit 11 is adapted to encrypt text PT received via the channel 12 in order to protect its transmission in encrypted form CT via the channel 13. It may also be adapted to receive via the channel 13 text CT in an encrypted form transmitted from another module and to decrypt it in order to supply decrypted text PT via the channel 12.

It should be noted that the combination function 51 and the cryptographic function 52 advantageously correspond to a method of partitioning the secret element into a plurality of partial secret information items that is applied by the secret element distribution center 21 to enable the cryptographic modules 20 to obtain the secret element from the plurality of partial secret information items transmitted.

FIG. 6 shows an embodiment of the present invention in which the first transmission is effected via the direct injection first channel c1 and the second transmission is effected via the radio channel c2 using an OTAR type protocol. The two cryptographic modules 20 obtain the common shared secret element independently of each other. They are then able to exchange information in a form encrypted as a function of the common secret element SK in particular.

FIG. 7 shows the architecture of a cryptographic module in another embodiment of the present invention. Such a cryptographic module 20 includes a cryptographic unit 11 that operates in accordance with a symmetrical cryptography algorithm that receives as input a session key SK that here is supplied by the unit 33 in an embodiment of the present invention for obtaining the secret element. The unit 33 may advantageously employ probabilistic encryption, for example using a bilinear shape and a group of points on an elliptical curve. Its principle may be similar to that explained in the document WO 03/017559 “Systems and method of identity-based encryption and related cryptographic techniques” (Boneh, Franklin).

According to such a principle, at the transmitting end a supplementary information item, here denoted Kₓ, is also obtained by the unit 33 and transmitted via the channel 13 in association with the encrypted stream CT.

According to this same principle, in order to decrypt a received text CT, there is required at the receiving end a secret information item relating to the individual identity of the destination cryptographic module concerned (respectively the identity of a group of destination cryptographic modules including said cryptographic module). Such an identity information item may then advantageously be transmitted to the cryptographic module in accordance with the secret element sharing method according to an implementation of the present invention, i.e. in at least two separate and strictly partial transmissions.

Accordingly, the secret element sharing method enables a cryptographic module to obtain a secret information item relating to the individual identity of said cryptographic module (specifically the identity of a group of cryptographic modules including said cryptographic module).

FIG. 8 shows a secret element distribution center 21 in an embodiment of the present invention. Such a distribution center is adapted to distribute the secret element to be shared in the form of at least two separate transmissions. To this end, it comprises a partitioning unit 81 adapted to partition the secret element SK to be shared into at least the first and second partial secret information items K₀ and K₁-Kₙ, respectively, using a particular partitioning method. The present invention covers all methods able to partition the secret element. A partitioning method is preferably used that avoids as much as possible redundancy of information between the first and second partial secret information items. This makes it possible to obtain a system based on a partial distribution of a secret element at the same time as supplying maximum entropy. The partitioning method therefore preferably verifies that an entropy value of the secret element is substantially equal to an entropy value resulting from summing the entropy values corresponding to the respective partial secret information items.

Such a distribution center comprises an interface 82 adapted to distribute both the first partial secret information item K₀, and the second partial secret information item K₁-Kₙ, to the various cryptographic modules, respectively by a first transmission, and by a second transmission separate from the first transmission, each transmission being strictly partial in relation to the secret element.

This interface is adapted to verify the characteristics of the first and second transmissions referred to above that enable those transmissions to be distinguished.

If the two transmissions are separate and are effected on two separate physical transmission channels, the interface 82 may advantageously comprise a first interface 83 adapted to effect the first transmission and a second interface 84 adapted to effect the second transmission separately from the first transmission.

As stated above, the first interface 83 may be adapted to transmit the first partial secret information item K₀ to a storage peripheral that may be connected directly to the cryptographic module 20 in order to inject this first partial secret information item into it.

The second interface 84 may be adapted to transmit the second partial secret information item K₀ via a radio channel using an OTAR type transmission protocol, for example.

The present invention may also be easily applied in a situation where sets of i keys are used, for example triplets of keys. In such a situation, if the cryptographic unit 11 requires a triplet of session keys SK_{A}, SK_{B} and SK_{C}, respective first partial secret information items K_{0A}, K_{0B} and K_{0C} may be transmitted in the form of a partial secret information items and the second partial secret information items transmitted also in the form of triplets of partial secret information items, in the same manner as explained above in relation to a single secret element SK. The unit 33 in an embodiment of the present invention is then adapted to obtain the corresponding session keys SK_{A}, SK_{B} and SK_{C}.

The present invention is in no way limited to two separate transmissions. In fact, as soon as the secret element to be shared is ‘split’ into more than two partial secret information items, it may be advantageous to use a greater number of separate transmissions to increase the protection against attack.

Generally speaking, by means of such provisions, it is possible to transmit strictly partial secret information items in parallel and independently on physical channels that advantageously cannot all be monitored by a third party.

The present invention also finds applications to transmitting secret elements in the context of asymmetrical encryption. In fact, in an implementation of the present invention the secret element may correspond to a private key, a secret key, or a point on an elliptical curve. Regardless of the field of application of the present invention, it advantageously provides great flexibility, in particular with regard to the length of the secret element to be distributed, regardless of the transmission protocol used, even if the protocol involves a size limitation in relation to the secret element transmitted.

The present invention is in no way limited as to the type of secret element to be distributed, and such elements may in particular correspond to a synchronization information item, an identity information item or a key management item.

Thus the present invention has the advantage that it may be easily implemented in a cryptographic system to provide greater flexibility regarding the size of the common secret element to be distributed by transmitting it in the form of at least two independent separate transmissions of secret and strictly partial information. In such a context, apart from the flexibility as to the size of the secret element, the protection of the secret character of the element to be distributed may be enhanced since an attack entails monitoring at least two separate and independent transmissions.

Moreover, to limit the number of transmission messages, the present invention proposes to transmit the secret element having a certain entropy value in the form of a plurality of partial secret information items for which the sum of the respective entropy values is substantially equal to the entropy value of the secret element, in contrast to the ‘broadcast encryption’ type system described above in which the entropy of the secret element is substantially identical to the entropy of each of the partial information items.

1. A method of sharing a secret element with at least one cryptographic module, wherein the secret element can be obtained from at least first and second partial secret information items, said method comprising:
a first transmission for transmitting the first partial secret information to the cryptographic module but not the second partial information item;
a second transmission for transmitting the second partial secret information item to the cryptographic module but not the first partial information item, said second transmission being separate from the first transmission; and
obtaining the secret element in the cryptographic module from the first and second partial secret information items transmitted.

2. The sharing method according to claim 1, wherein an entropy value corresponding to the secret element is substantially equal to the sum of respective entropy values corresponding to the first partial secret information item and to the second partial secret information item.

3. The sharing method according to claim 1, wherein the first transmission is effected in a first physical transmission channel, and the second transmission is effected in a second physical transmission channel separate from the first physical channel.

4. The sharing method according to claim 3, wherein the first and second physical channels are radio channels using different respective radio technologies.

5. The sharing method according to claim 3, wherein the first physical channel is a cable channel with direct injection into the cryptographic module and the second physical channel is a radio channel.

6. The sharing method according to claim 3, wherein the first physical channel corresponds to a connection of the cryptographic module to a storage peripheral and the second physical channel is a radio channel.

7. The sharing method according to claim 1, wherein the first transmission is effected in a first logical transmission channel and the second transmission is effected in a second logical transmission channel separate from said first logical channel but established on the same physical channel as the first logical channel.

8. The sharing method according to claim 1, wherein the step the secret element is obtained by applying a one-way function to the first partial secret information item and the second partial secret information item.

9. A cryptographic method implemented in a cryptographic module using a secret element, wherein said secret element is obtained from at least first and second partial secret information items by a sharing method according to claim 1.

10. The cryptographic method according to claim 9 when implemented using a personalized key.

11. The cryptographic method according to claim 10, wherein the personalized key and the first partial secret information item are received in the cryptographic module via the same physical channel.

12. A cryptographic module of a cryptographic system adapted to share a secret element that can be obtained from at least first and second partial secret information items, said partial secret information items enabling said secret element to be obtained, said cryptographic module comprising:
a receive interface adapted to receive, by a first transmission, said first partial secret information item but not the second partial information item and to receive, by a second transmission separate from the first transmission, said second partial secret information item but not the first partial information item;
a unit for obtaining secret elements adapted to obtain said secret element from said first and second partial secret information items; and
a cryptographic unit adapted to execute a cryptographic operation on the basis of said secret element.

13. The cryptographic module according to claim 12, wherein the receive interface comprises:
a first interface adapted to receive said first partial secret information item; and
a second interface separate from the first interface and adapted to receive said second partial secret information item.

14. The cryptographic module according to claim 12, wherein the first interface is adapted to receive the first partial secret information item via a direct injection cable channel and the second interface is adapted to receive the second partial secret information item via a radio channel.

15. The cryptographic module according to claim 14, wherein the direct injection channel corresponds to a connection to a storage peripheral.

16. The cryptographic module according to claim 12, wherein the cryptographic unit is adapted to effect cryptographic operations using a personalized key as a parameter and the first interface is further adapted to route the personalized key to the cryptographic unit and the first partial secret information item to the unit for obtaining secret elements.

17. The cryptographic module according to claim 12, further adapted to share with another cryptographic module a secret information item relating to an individual identity of said cryptographic module.

18. The cryptographic module (20) according to claim 12, further adapted to share a secret information item relating to an identity of a group of cryptographic modules, said cryptographic module belonging to said group of cryptographic modules.

19. A terminal comprising a cryptographic module according to claim 12.

20. A center for distribution of a secret element in a cryptographic system comprising a plurality of cryptographic modules, said distribution center, comprising:
a partitioning unit adapted to partition a secret element into at least first and second partial secret information items, said secret element being obtainable from said partial secret information items; and
an interface adapted to distribute said first partial secret information item but not the second partial secret information item, respectively said second partial secret information item but not the first partial secret information item, to said plurality of cryptographic modules, by a first transmission, respectively by a second transmission separate from the first transmission.

21. The secret element distribution center according to claim 20, wherein the interface comprises:
a first interface adapted to perform the first transmission; and
a second interface adapted to perform a second transmission separate from said first transmission.

22. The secret element distribution center according to claim 21, wherein the first interface is adapted to transmit the first partial secret information item to a storage peripheral.

23. The secret element distribution center according to claim 21, wherein the second interface is adapted to transmit the second partial secret information item via a radio channel.

24. (canceled)
